(19) United States
(12) Patent Application Publication
(10) Pub. No.: US 2020/0183385 A1
(43) Pub. Date: Jun. 11, 2020

(54) NETWORK CONTROL DEVICE AND METHOD THEREOF AND ELECTRONIC CONTROL UNIT FOR VEHICLE

(71) Applicants: Inventec (Pudong) Technology Corporation, Shanghai (CN); INVENTEC CORPORATION, Taipei (TW)

(72) Inventor: Wen Bin HU, Shanghai (CN)

(21) Appl. No.: 16/240,941

(22) Filed: Jan. 7, 2019

(30) Foreign Application Priority Data
Dec. 7, 2018 (CN) 201811497523.6

(51) Int. Cl. G05D 1/00; H04L 29/08; G07C 5/08; H04L 1/22

(52) U.S. Cl. CPC G05D 1/0077; H04L 1/22; G07C 5/0816; H04L 67/125

(57) ABSTRACT

The present disclosure provides a network control device, a network control method and an electronic control unit for a vehicle. The network control device includes: a first network controller and a second network controller; at least one network interface, with each network interface controlled by the first network controller or the second network controller; and at least one network interface selector respectively connected between each network interface and either the first network controller or the second network controller, wherein the at least one network interface selector selects the first network controller or the second network controller for each network interface to be connected respectively according to a control signal received from the first network controller or the second network controller.

### CROSS-REFERENCE TO RELATED APPLICATIONS

This non-provisional application claims priority under 35 U.S.C. § 119(a) on Patent Application No(s). 201811497523.6 filed in China on Dec. 7, 2018, the entire contents of which are hereby incorporated by reference.

### BACKGROUND

### 1. Technical Field

The present disclosure is related to the field of auto technology, more particularly related to the field of network control technology. Specifically, the present disclosure is related to a network control device, a network control method and an electronic control unit for a vehicle.

### 2. Related Art

The technology of autopilot is developed rapidly, and ADAS as well as in-vehicle entertainment becomes more and more advanced. On the base of traditional vehicles, the number of electronic control units installed in vehicles increases gradually. Due to the complexity and diversity of arrangements of the electronic control units, the risk of malfunction of the vehicles is higher than the risk of malfunction of the traditional vehicles. Once the malfunction occurs, the personal safety will be negatively affected. Therefore, the consideration of the safety design for electronic control units is significantly important.

LAN is widely used and plays an important role in the autopilot technology. For example, POE network cameras collect images around the roads in real-time and transmit the images to a CPU for processing through network interfaces. If one of the processors is failed, it may cause a vehicle to lose control and impact due to the failure would be serious.

In the conventional hardware design of LAN, a single network interface corresponds to a single network controller, and there is no other solution for emergency.

In general, the current hardware design of LAN in autopilot has disadvantages shown in the following:

1) A single network interface corresponds to a single network controller. In this case, if the controller is failed, the information of network equipment cannot be transmitted to the CPU. As a result, the vehicle will lose necessary information needed for autopilot.

2) There is no effective solutions for possible failures, and accordingly the safety of a driver would be negatively affected.

### SUMMARY

In view of the above disadvantages of the prior art, the purpose of the present disclosure is to provide a network control device, a network control method and an electronic control unit for a vehicle for addressing the problem of failed transmission of information of network equipment of vehicles caused by failed network controllers in prior art.

In order to achieve the above purpose and other related purposes, an embodiment of the present disclosure provides a network control device. The network control device includes: a first network controller and a second network controller; at least one network interface, with each network interface controlled by the first network controller or the second network controller; and at least one network interface selector respectively connected between each network interface and either the first network controller or the second network controller, wherein the at least one network interface selector selects the first network controller or the second network controller for each network interface to be respectively connected to according to a control signal received from the first network controller or the second network controller.

In one embodiment of the present disclosure, the network interface selector controls the network interface to be connected to the first network controller when receiving the control signal from the first network controller; and the network interface selector controls the network interface to be connected to the second network controller when receiving the control signal from the second network controller.

In one embodiment of the present disclosure, the network control device further includes a main controller, wherein each of the first network controller and the second network controller is connected to the main controller, the main controller controls the first network controller to generate the control signal when communicating with the first network controller, and the main controller controls the second network controller to generate the control signal when communicating with the second network controller.

In one embodiment of the present disclosure, each of the first network controller and the second network controller is a network controller with a model number of NHI350AM4.

In one embodiment of the present disclosure, the network interface selector has a characteristic of alternative selection for the network interface to be controlled by the two network controller.

In one embodiment of the present disclosure, the network interface selector is a network interface selector with a model number of PI3L720HEX.

One embodiment of the present disclosure further provides an electronic control unit for a vehicle including the above-described network control device.

One embodiment of the present disclosure further provides a network control method. The network control method includes: providing a first network controller and a second network controller; and providing each of a plurality of network interface selectors to a respective one of a plurality of network interfaces, with each network interface selector connected between the respective network interface and either the first network controller or the second network controller, wherein each network interface selector selects the first network controller or the second network controller for the respective network interface to be respectively connected to according to a control signal received from the first network controller or the second network controller.

In one embodiment of the present disclosure, the network interface selector controls the network interface to be connected to the first network controller when receiving the control signal from the first network controller; and the network interface selector controls the network interface to be connected to the second network controller when receiving the control signal from the second network controller.

In one embodiment of the present disclosure, each of the first network controller and the second network controller is connected to the main controller, the main controller controls the first network controller to generate the control signal when communicating with the first network controller, and the main controller controls the second network controller to generate the control signal when communicating with the second network controller.

As described above, the network control device, the network control method and the electronic control unit for the vehicle provided by the present disclosure have the advantages shown in the following:

The present disclosure provides a decentralized design of LAN in autopilot, in which the low-cost network interface selector and the network controller are combined together. Through the characteristic of alternative selection of the network interface selector, a single network can be controlled by two network controllers. Accordingly, when one of the two network controllers is failed, the other one of the two network controllers would takes over the control, so that a traffic accident caused by the failed network controller can be avoided in the process of operating a vehicle.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a structural diagram of a network control device according to one embodiment of the present disclosure;

FIG. 2 is a preferable structural diagram of a network control device according to one embodiment of the present disclosure;

FIG. 3 is a diagram of network connections of a network control device according to one embodiment of the present disclosure;

FIG. 4 is a diagram of a specific structure of a network interface selector according to one embodiment of the present disclosure; and

FIG. 5 is a flow chart of a network control method according to one embodiment of the present disclosure.

### DETAILED DESCRIPTION

The embodiments of the present disclosure are described below by the way of specific example, and persons skilled in the art would understand advantages and effects of the present disclosure according to the contents disclosed in the specification. The present disclosure may be embodied or applied in various specific examples, and the details of the specification may be modified or changed based on various aspects and applications without departing from the spirit and scope of the present disclosure.

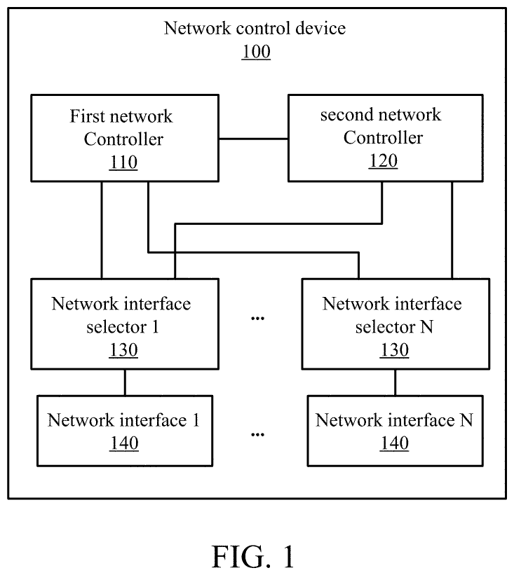

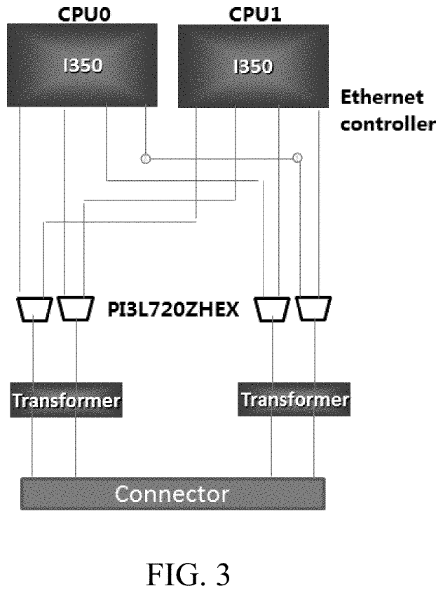

Please refer to FIG. 1 to FIG. 5. It is noted that the structures, the proportions, the sizes are used for illustration in the specification of the present disclosure for those skilled in the art to understand and read, and not intended to limit implementations of the present disclosure and accordingly they do not include any technical meanings. Any modifications of structures, changes of the proportions or adjustments of sizes will fall within the scope of the present disclosure without affecting the effects and the purposes of the present disclosure.

Meanwhile, the terms mentioned in the specification, such as “above”, “below”, “left”, “right”, “middle” and “one”, are merely for illustration purposes, and not intended to limit the scope of the present disclosure. Changes or adjustments in corresponding relationship should be considered as being within the scope of the present disclosure without substantially changing technical contents.

The purpose of the embodiments of the present disclosure is to provide a network control device, a network control method and an electronic control unit for a vehicle in order to solve the problem of failed transmission of information of network equipment of vehicles caused by failed network controllers in prior art.

Detailed descriptions for principles and implementations of a network control device, a network control method and an electronic control unit for a vehicle in embodiments of the present disclosure will be given in the following paragraphs, so that those skilled in the art would understand the network control device, the network control method and the electronic control unit for the vehicle without creative efforts.

### Embodiment 1

As shown in FIG. 1, a network control device 100 is provided in the embodiment. The network control device 100 includes: a first network controller 110 and a second network controller 120, at least one network interface 140 and at least one network interface selector 130.

The detailed descriptions regarding the network control device 100 of the embodiment will be given in the following paragraphs.

In the embodiment, the network control device 100 includes two network controller: the first network controller 110 and the second network controller 120. Each network interface 140 is controlled by the first network controller 110 or the second network controller 120.

In the embodiment, the network control device 100 includes at least one network interface 140 such as the network interface 140 1 to the network interface 140 N shown in FIG. 1. The network control device 100 correspondingly includes at least one network interface selector 130 such as the network interface selector 130 1 to the network interface selector 130 N shown in FIG. 1. The number of the network interface 140 is correspondingly identical to the number of the network interface selector 130.

Each network interface selector 130 is connected between the network interface 140 and either the first network controller 110 or the second network controller 120. The network interface selector 130 selects the first network controller 110 or the second network controller 120 for each network interface 140 to be respectively connected to according to a control signal received from the first network controller 110 or the second network controller 120.

In other words, the network controller correspondingly connected to the network interface 140 is controlled through the network interface selector 130.

Specifically, in the embodiment, the network interface selector 130 controls the network interface 140 to be connected to the first network controller 110 when receiving the control signal from the first network controller 110. The network interface selector 130 controls the network interface 140 to be connected to the second network controller 120 when receiving the control signal from the second network controller 120.

Through the network interface selector 130, each network interface 140 can be controlled by the two network controllers. As a result, in the process of operating a vehicle, when one of the network controllers is failed, it is possible to rapidly switch to the other one of the network controllers to control the network interface 140. Thereby, the potential danger caused by the failed network controller can be avoided.

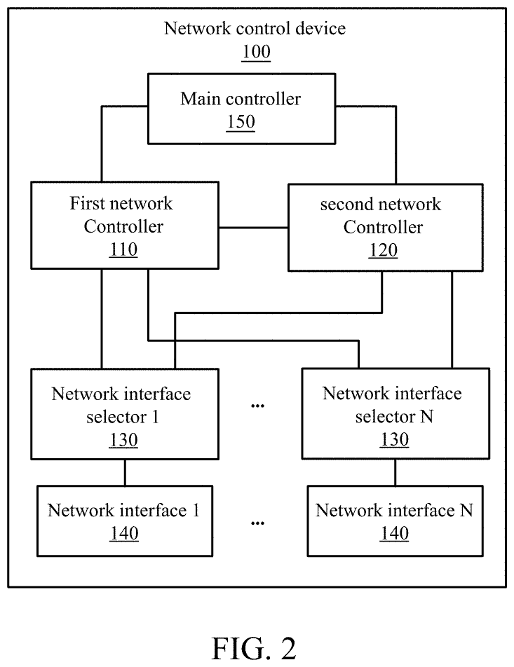

In this embodiment, as shown in FIG. 2, the network control device 100 further includes: a main controller 150.

Each of the first network controller 110 and the second network controller 120 is connected to the main controller 150. When the first network controller 110 is communicated with the main controller 150, the main controller 150 controls the first network controller 110 to generate the control signal. When the second network controller 120 is communicated with the main controller 150, the main controller 150 controls the second network controller 120 to generate the control signal.

In this embodiment, each of the first network controller 110 and the second network controller 120 is a network controller with model number NHI350AM4, but the present disclosure is not limited to the embodiment.

In this embodiment, the network interface selector 130 has a characteristic of alternative selection, so the network interface can be controlled by the two network controller.

Specifically, in the embodiment, the model number of the network interface selector 130 is PI3L720ZHEX, but the present disclosure is not limited to the embodiment.

PI3L720ZHEX is a low-cost network interface selector 130 (namely a LAN switch), with the PI3L720ZHEX network interface selector coming with a function of two-path selection which is capable of flexibly switching the connection between the network controllers and the network interface 14.

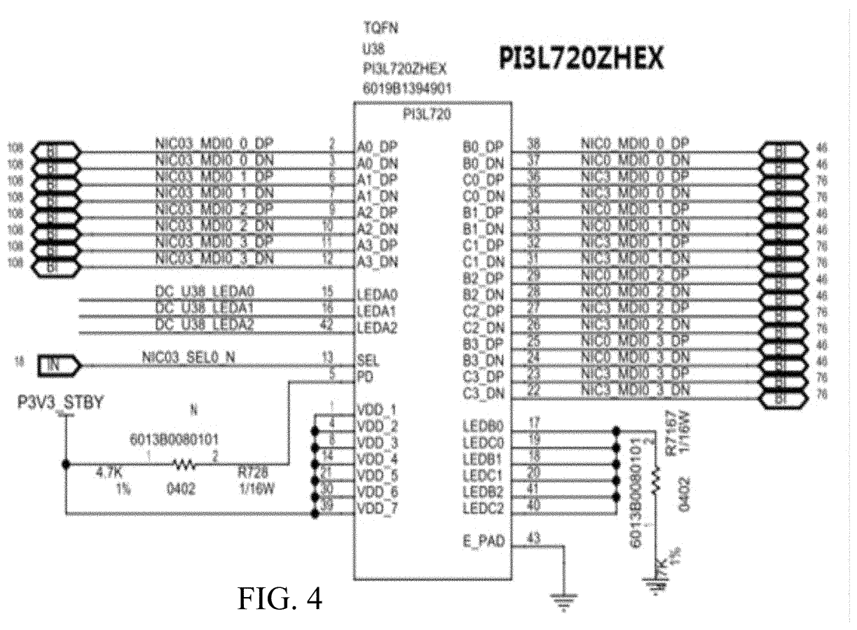

The specific circuit diagram of PI3L720ZHEX is shown in FIG. 4.

NHI350AM4 is a network controller. PI3L720ZHEX is a connector for operation of an Ethernet controller corresponding to the network interface 140. Therefore, PI3L720ZHEX may be adapted to determine using which Ethernet controller to control the corresponding network interface 140 to work. PI3L720ZHEX selects a selection signal from the first network controller 110 of CPU0 or the second network controller 120 of CPU1 by controlling SEL pins.

Accordingly, the embodiment provides a decentralized design of LAN in autopilot, in which the low-cost network interface selector PI3L720ZHEX and the network controller NHI350AM4 are combined together. Through the characteristic of alternative selection of the network interface selector PI3L720ZHEX, a single network can be controlled by two network controllers. Accordingly, when one of the two network controllers is failed, the other one of the two network controllers would takes over the control, so that a traffic accident caused by the failed network controller can be avoided in the process of operating a vehicle.

Based on verifications, the network control device 100 mentioned in the embodiment has characteristics of low-costs and reliable controls and is adapted to hardware design for LAN modules in autopilot.

An embodiment of the present disclosure further provides an electronic control unit for a vehicle. The electronic control unit for the vehicle includes the network control device 100 mentioned above. The detailed descriptions of the network control device 100 has been given, so not repeated here.

### Embodiment 2

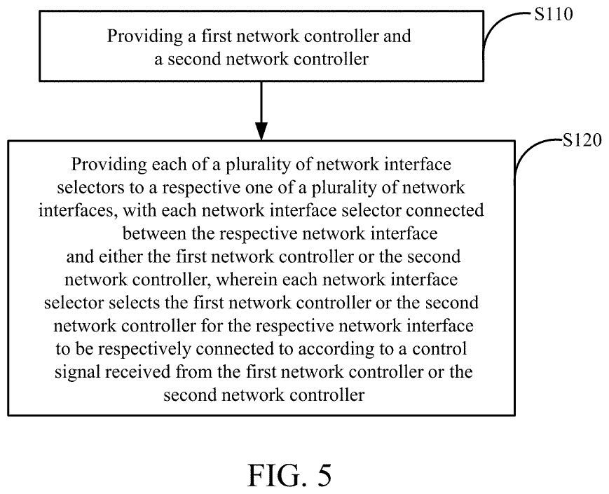

As shown in FIG. 5, an embodiment of the present disclosure further provides a network control method, and the network control method includes:

In step S110, a first network controller 110 and a second network controller 120 are provided.

In step S120, each of a plurality of network interface selectors is provided to a respective one of a plurality of network interfaces. Each network interface selector is connected between the respective network interface and either the first network controller or the second network controller, and each network interface selector selects the first network controller or the second network controller for the respective network interface to be respectively connected to according to a control signal received from the first network controller or the second network controller.

Detailed descriptions for step S110 and step S120 of the network control method in the embodiment will be given in the following paragraphs.

In the embodiment, two network controllers, the first network controller 110 and the second network controller 120, are used. Each network interface 140 is respectively controlled by the first network controller 110 or the second network controller 120.

In the embodiment, at least one network interface 140 is included. For example, as shown in FIG. 1, a network interface 140 1 to a network interface 140 N are included.

Correspondingly, at least one network interface selector 130 is included. For example, as shown in FIG. 1, a network interface selector 130 1 to a network interface selector 130 N are included. The number of the network interfaces 140 and the number of the network interface selectors 130 are identical to each other.

Each network interface selector 130 is connected between the network interface 140 and either the first network controller 110 or the second network controller 120. The network interface selector 130 selects the first network controller 110 or the second network controller 120 for each network interface 140 to be respectively connected to according to a control signal received from the first network controller 110 or the second network controller 120.

In other words, the network controller correspondingly connected to the network interface 140 is controlled through the network interface selector 130.

Specifically, in the embodiment, the network interface selector 130 controls the network interface 140 to be connected to the first network controller 110 when receiving the control signal from the first network controller 110. The network interface selector 130 controls the network interface 140 to be connected to the second network controller 120 when receiving the control signal from the second network controller 120.

Through the network interface selector 130, each network interface 140 can be controlled by the two network controllers. As a result, in the process of operating a vehicle, when one of the network controllers is failed, it is possible to rapidly switch to the other one of the network controllers to control the network interface 140. Thereby, the potential danger caused by the failed network controller can be avoided.

In the embodiment, each of the first network controller 110 and the second network controller 120 is connected to a main controller 150. When the first network controller 110 is communicated with the main controller 150, the main controller 150 controls the first network controller 110 to generate the control signal. When the second network controller 120 is communicated with the main controller 150, the main controller 150 controls the second network controller 120 to generate the control signal.

In the embodiment, each of the first network controller 110 and the second network controller 120 is a network controller with model number NHI350AM4, but the present disclosure is not limited to the embodiment.

In the embodiment, the network interface selector 130 has a characteristic of alternative selection, so the network interface 140 can be controlled by the two network controller.

Specifically, in the embodiment, a model number of the network interface selector 130 is PI3L720ZHEX, but the present disclosure is not limited to the embodiment.

PI3L720ZHEX is a low-cost network interface selector 130 (namely a LAN switch), with the PI3L720ZHEX network interface selector coming with a function of two-path selection which is capable of flexibly switching the connection between the network controllers and the network interface 14.

The specific circuit diagram of PI3L720ZHEX is shown in FIG. 4.

NHI350AM4 is a network controller. PI3L720ZHEX is a connector for operation of an Ethernet controller corresponding to the network interface 140. Therefore, PI3L720ZHEX may be adapted to determine using which Ethernet controller to control the corresponding network interface 140 to work. PI3L720ZHEX selects a selection signal from the first network controller 110 of CPU0 or the second network controller 120 of CPU1 by controlling SEL pins.

Accordingly, the embodiment provides a decentralized design of LAN in autopilot, in which the low-cost network interface selector PI3L720ZHEX and the network controller NHI350AM4 are combined together. Through the characteristic of alternative selection of the network interface selector PI3L720ZHEX, a single network can be controlled by two network controllers. Accordingly, when one of the two network controllers is failed, the other one of the two network controllers would takes over the control, so that a traffic accident caused by the failed network controller can be avoided in the process of operating a vehicle.

Based on verifications, the network control device 100 mentioned in the embodiment has characteristics of low-costs and reliable controls and is adapted to hardware design for LAN modules in autopilot.

Furthermore, in order to emphasize the creative part of the present disclosure, technical features which are not mainly addressing the technical problem mentioned in the present disclosure are not incorporated, however, it does not mean that other structure and functional features are not included in the embodiment.

It is noted that the drawings provided in the embodiment are merely used for illustrate the basic concept of the present disclosure, so the drawings show the components related to the present disclosure instead of showing the components according to the number, shape and size in actual implementation. The number, shape and size of each of the components can be modified randomly and the arrangements of the components might be more complicated.

Based on the above descriptions, the present disclosure provides a decentralized design of LAN in autopilot, in which the low-cost network interface selector 130 and the network controller are combined together. Through the characteristic of alternative selection of the network interface selector 130, a single network can be controlled by two network controllers. Accordingly, when one of the two network controllers is failed, the other one of the two network controllers would takes over the control, so that a traffic accident caused by the failed network controller can be avoided in the process of operating a vehicle. Therefore, the present disclosure efficiently overcomes various shortcomings of the prior art and has a high value of industrial utilization.

The above embodiments are merely used for illustrating the principle and advantages of the present disclosure, and are not intended to limit the present disclosure. Modifications and changes of the above embodiments may be made by persons skilled in the art without departing from the spirit and the scope of the present disclosure. Therefore, all equivalent modifications and changes, made by persons skilled in the art without departing from the spirit and the scope of the present disclosure, are still to be covered by the appended claims.

What is claimed is:

1. A network control device, comprising:
a first network controller and a second network controller;
at least one network interface, with each network interface controlled by the first network controller or the second network controller; and
at least one network interface selector respectively connected between each network interface and either the first network controller or the second network controller, wherein the at least one network interface selector selects the first network controller or the second network controller for each network interface to be respectively connected to according to a control signal received from the first network controller or the second network controller.

2. The network control device according to claim 1, wherein the network interface selector controls the network interface to be connected to the first network controller when receiving the control signal from the first network controller; and the network interface selector controls the network interface to be connected to the second network controller when receiving the control signal from the second network controller.

3. The network control device according to claim 1, further comprising:
a main controller, wherein each of the first network controller and the second network controller is connected to the main controller, the main controller controls the first network controller to generate the control signal when communicating with the first network controller, and the main controller controls the second network controller to generate the control signal when communicating with the second network controller.

4. The network control device according to claim 1, wherein each of the first network controller and the second network controller is a network controller with a model number of NHI350AM4.

5. The network control device according to claim 1, wherein the network interface selector has a characteristic of alternative selection for the network interface to be controlled by the two network controller.

6. The network control device according to claim 1, wherein the network interface selector is a network interface selector with a model number of PI3L720ZHEX.

7. An electronic control unit for a vehicle, comprising the network control device of claim 1.

8. A network control method, comprising:
providing a first network controller and a second network controller; and
providing each of a plurality of network interface selectors to a respective one of a plurality of network interfaces, with each network interface selector connected between the respective network interface and either the first network controller or the second network controller, wherein each network interface selector selects the first network controller or the second network controller for the respective network interface to be respectively connected to according to a control signal received from the first network controller or the second network controller.

9. The network control method according to claim 8, wherein the network interface selector controls the network interface to be connected to the first network controller when receiving the control signal from the first network controller; and the network interface selector controls the network interface to be connected to the second network controller when receiving the control signal from the second network controller.

10. The network control method according to claim 8, wherein each of the first network controller and the second network controller is connected to a main controller, the main controller controls the first network controller to generate the control signal when communicating with the first network controller, and the main controller controls the second network controller to generate the control signal when communicating with the second network controller.
